(19) United States
(12) Patent Application Publication
(10) Pub. No.: US 2025/0351848 A1
(43) Pub. Date: Nov. 20, 2025

(54) CONTROLLING PRODUCTION OF H2S IN BEVERAGES FOR PACKING IN ALUMINUM CONTAINING PACKAGES

(71) Applicant: BALL CORPORATION, WESTMINSTER, CO (US)

(72) Inventor: Brent C. TRELA, SUPERIOR, CO (US)

(21) Appl. No.: 19/282,202

(22) Filed: Jul. 28, 2025

Related U.S. Application Data
(62) Division of application No. 17/299,487, filed on Jun. 3, 2021, now Pat. No. 12,369,607.
(60) Provisional application No. 62/774,642, filed on Dec. 3, 2018.

(51) Int. Cl. A23L 2/54; A23L 2/38; A23L 2/70; B65D 25/14

(52) U.S. Cl. CPC A23L 2/54; A23L 2/382; A23L 2/70; B65D 25/14

(57) ABSTRACT

Packaging a fermented beverage in an aluminum-bearing or containing vessel includes controlling a concentration of sulfur dioxide within the fermented beverage. The concentration of the sulfur dioxide is decreased by subjecting the fermented beverage to a chemical process in batch or in-line and prior to filling the vessel or after filling the vessel.

### CROSS-REFERENCE TO RELATED APPLICATIONS

This Application is divisional of U.S. patent application Ser. No. 17,299,487, filed on Jun. 3, 2021, and now U.S. Pat. No. 12,369,607, issued on Jul. 29, 2025, which was a United States National Stage Application under 35 U.S.C. Section 371 of International Patent Application No. PCT/US2019/064178 filed on Dec. 3, 2019, both of which are hereby incorporated by reference as if fully set forth herein. This Application also claims priority to and the benefit of U.S. Provisional Application No. 62/774,642, filed Dec. 3, 2018, which is also hereby incorporated by reference as if fully set forth herein.

### FEDERALLY SPONSORED RESEARCH OR DEVELOPMENT

N/A

### TECHNICAL FIELD

The invention generally relates to storing beverages in aluminum containers; more particularly this invention relates to controlling hydrogen sulfide production in acidic beverages containing sulfur dioxide and stored in aluminum containers.

### BACKGROUND OF THE INVENTION

For some time and with mixed success, beverage makers have attempted to store and market fermented beverages, such as wine and cider, in aluminum-based containers, typically the popular two-piece, stay-on tab aluminum beverage cans produced by the billions each year. The mixed results are often attributed to an undesirable taste of the beverage stored within the containers. It is believed that one cause of the undesirable taste is an aroma of hydrogen sulfide produced by acid corroding the aluminum container in the presence of sulfur dioxide.

For example, a typical wine has a pH range of 3 to 4 while beer has a pH typically less than 5. Carbonated soft drinks also have a pH less than 5. Therefore, pH range alone may not account for a deterioration of the taste of a beverage stored in an aluminum container.

Use of sulfur dioxide is widely accepted in the art of winemaking. It is used as a preservative due to its anti-oxidative and anti-microbial properties in wine and a cleaning agent for barrels and winery facilities.

Hydrogen sulfide is known as having an objectionable “rotten egg” odor which is highly undesirable among the wine-consuming public. One approach to addressing the production of hydrogen sulfides in wine is to coat the interior walls of the aluminum container with a thicker than normal coating. Application of coatings on the interior walls of aluminum beverage containers is well known in the art. However, it has been theorized that thicker or heavier coatings scalp flavors from beverages.

The present invention is provided to solve the problems discussed above and other problems, and to provide advantages and aspects not provided by prior aluminum packaging of this type. A full discussion of the features and advantages of the present invention is deferred to the following detailed description, which proceeds with reference to the accompanying drawings.

### SUMMARY OF THE INVENTION

A first method of packaging a fermented beverage in an aluminum-bearing container comprises the step of decreasing the concentration of sulfur dioxide in the fermented beverage, optionally by subjecting the fermented beverage to a chemical process.

The first method may include one or more of the following steps and features, alone or in any reasonable combination. The step of decreasing the concentration of sulfur dioxide may be performed prior to a step of introducing the fermented beverage into the aluminum-bearing container. The step of decreasing the concentration of sulfur dioxide may be performed after the step of introducing the fermented beverage into the aluminum-bearing container. The chemical process may be a batch process. The chemical process may be performed in-line to a fluid flow of the fermented beverage. The chemical process may comprise micro-oxygenation. The chemical process may comprise an addition of hydrogen peroxide to the fermented beverage. The chemical process may comprise exposing the fermented beverage to an aldehyde-containing material. The chemical process may comprise introducing the fermented beverage into the aluminum-bearing container wherein the aluminum-bearing container comprises an aldehyde-containing material on an interior surface thereof in contact with the fermented beverage. A PH of the fermented beverage may be increased. A pH of the fermented beverage may be greater than or equal to 3.5 wherein an amount of molecular sulfur dioxide is decreased and a chemical solution of a system defined by the fermented beverage within an aluminum-bearing container is altered wherein the pH is such that an aluminum of the aluminum-bearing container is at least partially passivated and not prone to corrosion. The method may further comprise the step of adding an antioxidant to the fermented beverage. The chemical process may comprise adding one or more phenolics, including nonflavonoids, such as hydroxycinnamates, benzoic acids, hydrolysable tannins, stilbenes (resveratrol), and/or flavonoids, such as anthocyanins, proanthocyanidins and condensed tannins, among others, and/or aldehydes to the beverage. The one or more phenolics and aldehydes may be chosen from the group consisting of resveratrol and acetaldehyde. The method may further comprise a step of exposing the fermented beverage to oxygen wherein the oxygen initiates oxidation processes (some indirect or through intermediary radicals) that can end with ethanol being oxidized to acetaladehyde that reacts with SO₂, decreasing its concentration. The oxygen may react with a quantity of the sulfur dioxide greater than a quantity of the oxygen added to the fermented beverage. A concentration of oxygen added to the fermented beverage may be at least four times greater than a concentration of sulfur dioxide within the fermented beverage prior to adding oxygen to the fermented beverage. The chemical process may include the step of oxidizing ethanol to form acetaldehyde, which is then bound by sulfur dioxide. A concentration of molecular sulfur dioxide may be less than 0.4 mg/L.

A second method of the present invention is directed to preparing a fermented beverage for packaging in an aluminum-bearing container. The method comprises the step of decreasing a concentration of sulfur dioxide in the fermented beverage via chemical reaction.

The second method may comprise any of the following features or steps, along or in any reasonable combination. A pH of the fermented beverage may be increased. A pH of the fermented beverage may be greater than or equal to 3.5 wherein an amount of molecular sulfur dioxide is decreased and a chemical solution of a system defined by the fermented beverage within an aluminum-bearing container is altered wherein the pH is such that an aluminum of an aluminum-bearing container is at least partially passivated and not prone to corrosion. The method may further comprise the step of exposing the fermented beverage to an aldehyde. The method may further comprise the step of adding an antioxidant to the fermented beverage. The method may further comprise the step of adding one or more phenolics including nonflavonoids, such as hydroxycinnamates, benzoic acids, hydrolysable tannins, stilbenes (resveratrol), and/or flavonoids, such as anthocyanins, proanthocyanidins and condensed tannins, among others, and aldehydes to the fermented beverage. The one or more phenolics and aldehydes may be chosen from the group consisting of resveratrol and acetaldehyde. The method may further comprise the step of decreasing a concentration of sulfur dioxide within the fermented beverage prior to a step of introducing the fermented beverage into the aluminum-bearing container. The method may further comprise the step of decreasing a concentration of sulfur dioxide in the fermented beverage after a step of introducing the fermented beverage into the aluminum-bearing container. The method may further comprise the step of introducing oxygen into the fermented beverage through micro-oxygenation. The method may further comprise the step of adding a hydrogen peroxide to the fermented beverage. The method may further comprise the step of exposing the fermented beverage to an aldehyde-containing material. The method may further comprise the step of introducing the fermented beverage into the aluminum-bearing container wherein the aluminum-bearing container comprises an aldehyde-containing material on an interior surface thereof in contact with the fermented beverage. A concentration of molecular sulfur dioxide may be less than 0.4 mg/L.

A fermented beverage packaging of the present invention comprises a container comprising an aluminum and forming a substantially fluid-tight enclosure; a fermented beverage within the enclosure; and an antioxidant within the enclosure.

The fermented beverage packaging of the present invention may include one or more of the following features, alone or in any reasonable combination. The fermented beverage may have a concentration of molecular sulfur dioxide less than 0.4 mg/L. The fermented beverage may have been exposed to an aldehyde-containing material within the enclosure. The aldehyde-containing material may be a component of a coating on an interior surface of the enclosure. A pH of the fermented beverage may be greater than or equal to 3.5 wherein the pH is such that the aluminum of the container is at least partially passivated and not prone to corrosion. The antioxidant may comprise one or more phenolics. The one or more phenolics may comprise resveratrol. Oxygen may be added to the fermented beverage, and a concentration of the oxygen added to the fermented beverage may be greater than a concentration of sulfur dioxide within the fermented beverage. The fermented beverage may be subjected to a chemical process, wherein the chemical process includes oxidization of ethanol to form acetaldehyde, which is then bound by SO₂. A presence of the antioxidant may allow a concentration of sulfur dioxide in the fermented beverage to be decreased.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of an aluminum-bearing container filled with a fermented beverage; and

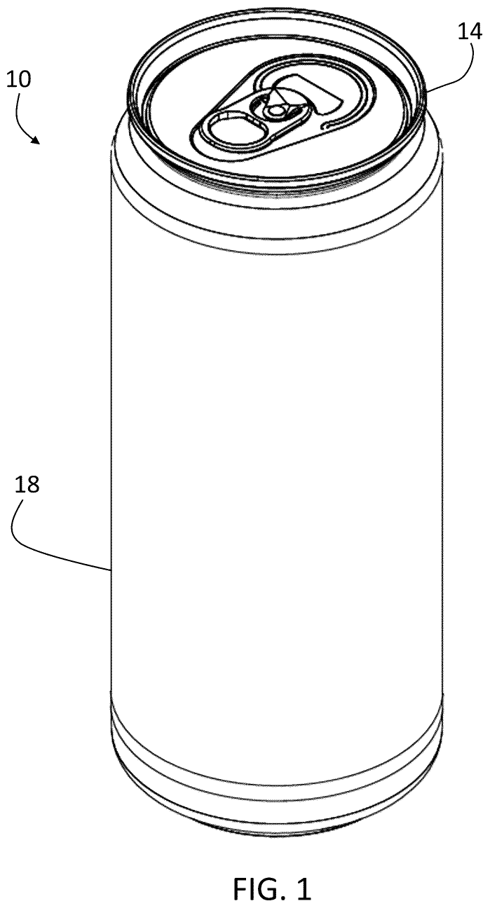

FIG. 2 is a cross-sectional view of the aluminum-bearing container of FIG. 1.

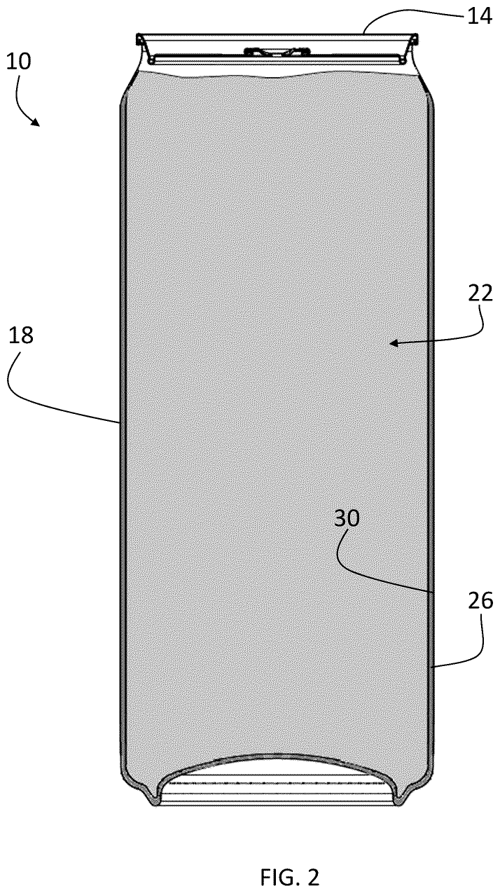

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The inventors believe that an acidic beverage containing sulfur dioxide (SO₂) containing beverages in the presence of metallic aluminum (container body and lid, foil, liner) produces hydrogen sulfide (H₂S), which is objectionable to consumers of the beverages. The methods described herein are aimed at decreasing or eliminating this process, preserving the beverage, and improving consumer acceptance.

The present invention addresses the problem of sulfide production in acidic, SO₂-containing beverages, such as fermented wines and ciders in aluminum containing packages.

The mechanism of the problem was discovered to be acid protons and naturally occurring or added sulfur dioxide permeating a barrier coating on the aluminum such as in a can body, or a plastic-foil laminate such as a roll on a pilfer-proof (ROPP) closure cap liner or bag-in-box pouch or paper, or cardboard carton. The protons cause corrosion of the aluminum solid, Al (s), to aluminum (III), an oxidation state 3+ (Al³⁺), which generates electrons that chemically reduce the SO₂ to H₂S, which is responsible for rotten egg type aromas. An aspect of the present invention is associated with understanding this mechanism and limiting the undesirable reaction through the limit or control of SO₂.

Generally, the invention includes lowering molecular SO₂ via various means: decreasing SO₂ use/free SO₂ additions; increasing beverage pH which decreases concentration of molecular SO₂; adding hydrogen peroxide H₂O₂ which oxidizes SO₂ to sulfurous acid (H₂SO₄):

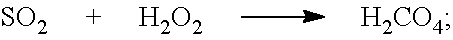

and using micro-oxygenation, or otherwise adding oxygen (O₂) to decrease SO₂ (usually through oxidizing ethanol to form acetaldehyde, which is then bound by SO₂); using/adding phenolics and aldehydes, e.g. additives and/or container coating types to lower SO₂; and adding antioxidant to lower SO₂ to potentially permit less use of SO₂ for a similar antioxidant purpose. SO₂ added to wine, either as dissolved SO₂ gas, or as various salts such as potassium metabisulfite (K₂S₂O₅) or sodium bisulfite (N₂S₂O₅), dissociates into SO₂. This is molecular SO₂. HSO₃-(bisulfite), and SO₃(2-) (sulfite), these species comprise the free SO₂, and the amounts of each are dependent on the pH. Each of these species are reactive to specific chemistries. If reacted/bound, they become bound SO₂. Total SO₂ is the sum of free species and bound SO₂.

Acetaldehyde (CH₃—CHO) concentration in a newly fermented wine is typically less than 75 mg/L.

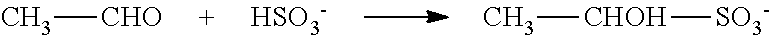

Each milligram of acetaldehyde will bind with 1.45 milligrams of SO₂ to form acetaldehyde-alpha-hydroxy sulphonate.

Adding aldehydes in a coating could actively bind SO₂ that permeates the coating.

Phenolics are different than aldehydes and tend to act as antioxidants. Its inclusion is believed to permit a winemaker to use less SO₂ for the same or similar effect.

In one embodiment, a beverage 22 is treated prior to packaging in an aluminum vessel 10 to decrease concentration of SO₂. The treatment comprises micro-oxygenation and/or addition of hydrogen peroxide (H₂O₂) in an in-line or batch process prior to seaming a can end 14 to a filled can body 18.

In one embodiment, the beverage 22 is treated to decrease concentration of SO₂ during or in packaging through micro-oxygenation and/or addition of hydrogen peroxide either in-line to the aluminum container 10 or as a batch process just prior to filling and seaming a can end 14 to the aluminum can body 18.

In one embodiment, the beverage 22 is treated while within an aluminum-bearing container body 18 by introducing aldehyde containing coating materials 26 to the can body 18 interior surface 30 prior to filling.

In one embodiment, a pH of a fermented beverage 22 is increased pH>3.5 to decrease an amount of molecular SO₂ as well as shift a chemical solution of a system defined by the fermented beverage within an aluminum-bearing container 10 wherein the pH is such that the aluminum of the aluminum-bearing container 10 is at least partially passivated and not prone to corrosion.

The pH is increased in order to decrease the molecular SO₂ concentration, but it does not necessarily have to be greater than or equal to pH 3.5. Any pH increase will decrease existing molecular SO₂ concentration and likely improve passivity of the Al. A pH of 3.5 or above is the preferred pH.

In one embodiment, the concentration of molecular sulfur dioxide is less than 0.4 mg/L.

It is believed that decreasing sulfur dioxide concentration and/or increasing pH of the fermented beverage decreases molecular sulfur dioxide, while increasing pH decreases molecular sulfur dioxide and increases aluminum passivation/resistance to corrosion. All of which combine to decrease hydrogen sulfide formation in sulfur dioxide-containing products exposed to aluminum.

Each of these embodiments may be batch processes prior to filling and enclosing a beverage 22 within an aluminum-bearing container, in-line, or within the aluminum container 10.

One method of the invention includes decreasing SO₂ concentration prior to packaging through an oxygen addition. This may include micro-oxygenation and/or addition of hydrogen peroxide as an in-line or batch process.

One method of the present invention may include decreasing SO₂ concentration during/in packaging through an oxygen addition. This includes micro-oxygenation and/or addition of hydrogen peroxide either in-line to packaging or as a batch process just prior to packaging.

One method of the present invention includes decreasing SO₂ concentration during/in packaging through an oxygen addition during and through a process of filling the packaging by encouraging exposure of a fermented beverage to oxygen. Dissolved oxygen (DO) concentration in still wine generally increases by about 0.5 mg/L during bottling under ideal, industry best practice conditions (1.0-1.5 mg/L under less ideal conditions). Although packaging carbonated wines/spritzers etc., it is possible to decrease/maintain DO concentration below 0.1 mg/L. Theoretically, 1.0 mg/L of oxygen can react with 4 mg/L of SO₂ to produce acetaldehyde. Thus, the process of bottling or canning a fermented beverage can also decrease concentration of SO₂.

One method includes the step of decreasing SO₂ concentration through an addition of a quantity of phenolics (e.g. resveratrol) or aldehydes (e.g. acetaldehyde) chemical agents or via a packaging containing materials such as aldehyde containing epoxies, e.g. formaldehyde or acetaldehyde. The phenolics may include nonflavonoids, such as hydroxycinnamates, benzoic acids, hydrolysable tannins, stilbenes (resveratrol), and/or flavonoids, such as anthocyanins, proanthocyanidins and condensed tannins, among others, and/or aldehydes. Antioxidants do not directly react with and decrease SO₂ concentration, but their use is believed to permit the winemaker to decrease his/her addition of SO₂ for the same or similar effect.

One method includes decreasing SO₂ concentration by increasing pH. In one illustrative example, pH is increased to greater than 3.5. Increasing pH, decreases molecular SO₂ concentration relative to other SO₂ forms. Increasing pH also improves the corrosion resistance of aluminum.

One method includes the step of adding an antioxidant, for example resveratrol, to decrease the need for SO₂, thus allowing the beverage producer/handler to decrease a concentration of SO₂ added to a beverage.

### Illustrative Examples

The present invention describes methods for controlling the production of H₂S in beverages that are filled in aluminum containing packages. It describes beverage product and process modifications before, during or just after filling to reduce or prevent H₂S formation. The following examples support a chemical reaction mechanism. Also, modification of the chemistry as outlined can protect the product.

This development applies to SO₂ and acid containing beverages common in products like fermented beverages such as wines and ciders and is aimed at defining ways that such beverage products can be modified just before, during or just after filling into an aluminum container to reduce the propensity for H₂S formulation.

Experiments were conducted to test efficacy of the principles of the invention. In these tests, 6 mm sized aluminum disks were subjected to various wine environments. The data presented below show average H₂S concentrations in various wines (a model wine, red wine, and white wine) at various pH and SO₂ concentrations after 14 days at 50° C. SO₂ concentrations above a few ppm yielded H₂S at concentrations greater than a sensory threshold, regardless whether SO₂ was added or was decreased in the sample by volatilizing the SO₂ through aeration or sparging the wine with a fluid, namely air or nitrogen gas, or through addition of hydrogen peroxide. Red wines offer additional protection due to SO₂ complexing tanning and color molecules.

TABLE 1
Average H₂S concentrations in a model white
wine (10% ethanol, 5 g/L potassium bitartrate) at pH
3.00 with a 6 mm Al disk after 14 days at 50° C.

| Free SO2 (mg/L) | pH | H2S (μg/L) |
|---|---|---|
| 0 | 3.0 | 0.0 |
| 3 | 3.0 | 0.0 |
| 10 | 3.0 | 0.0 |
| 17 | 3.0 | 11.7 |
| 25 | 3.0 | 24.6 |
| 29 | 3.0 | 27.5 |

TABLE 2
Red wine at constant 0.8 molecular SO₂ with 6
mm Al disk, yields decreasing H₂S with increasing pH

| Free SO2 (mg/L) | pH | H2S (μg/L) |
|---|---|---|
| 8 | 2.8 | 10.3 |
| 13 | 3.0 | 6.1 |
| 40 | 3.5 | 0.6 |

TABLE 3
In white wines with 6 mm Al disk, adjusting
pH and or SO₂ can have a significant impact, above pH
3.5 and molecular SO₂ less than 0.1 reduce H₂S to
below threshold levels.

| Free SO2 (mg/L) | pH | H2S (μg/L) |
|---|---|---|
| 0 | 3.6 | 0.0 |
| 3 | 3.5 | 0.5 |
| 10 | 3.2 | 21.2 |
| 15 | 3.4 | 16.1 |
| 19 | 3.3 | 30.0 |

While the specific embodiments have been illustrated and described, numerous modifications come to mind without significantly departing from the spirit of the invention. and the scope of protection is only limited by the scope of the accompanying Claims.

What is claimed is:

1. A fermented beverage packaging comprising:
a container comprising an aluminum and forming a substantially fluid-tight enclosure;
a fermented beverage within the enclosure; and
an antioxidant within the enclosure,
wherein the fermented beverage is chosen from the group consisting of wine and cider.

2. The fermented beverage packaging of claim 1 wherein the fermented beverage has a concentration of molecular sulfur dioxide less than 0.4 mg/L.

3. The fermented beverage packaging of claim 2 wherein the fermented beverage has been exposed to an aldehyde-containing material within the enclosure.

4. The fermented beverage packaging of claim 3 wherein the aldehyde-containing material is a component of a coating on an interior surface of the enclosure.

5. The fermented beverage packaging of claim 4 wherein a pH of the fermented beverage is greater than or equal to 3.5 wherein the pH is such that the aluminum of the container is at least partially passivated and not prone to corrosion.

6. The fermented beverage packaging of any of claims 1 wherein the antioxidant comprises one or more phenolics.

7. The fermented beverage packaging of claim 6 wherein the one or more phenolics comprises resveratrol.

8. The fermented beverage packaging of any of claims 2 wherein oxygen is added to the fermented beverage and a concentration of the oxygen added to the fermented beverage is greater than a concentration of sulfur dioxide within the fermented beverage.

9. The fermented beverage packaging of any of claims 2 wherein the fermented beverage is subjected to a chemical process, wherein the chemical process includes oxidization of ethanol to form acetaldehyde, which is then bound by SO₂.

10. The fermented beverage packaging of any of claims 2 wherein a presence of the antioxidant allows a concentration of sulfur dioxide in the fermented beverage to be decreased.

11. The fermented beverage packaging of claim 1 wherein the fermented beverage has a concentration of molecular sulfur dioxide less than 0.4 mg/L and wherein the fermented beverage is a white wine.

12. The fermented beverage packaging of claim 11 wherein a dissolved oxygen concentration in the fermented beverage is 0.5 mg/L or higher.

13. The fermented beverage packaging of claim 1 wherein the fermented beverage is a white wine.

14. A fermented beverage packaging comprising:
a container comprising an aluminum and forming a substantially fluid-tight enclosure;
a fermented beverage within the enclosure; and
an antioxidant within the enclosure,
wherein a concentration of molecular sulfur dioxide in the fermented beverage to a concentration of molecular sulfur dioxide less than 0.4 mg/L, and
a dissolved oxygen concentration in the fermented beverage is 0.5 mg/L or higher.
